(19) United States
(12) Patent Application Publication
(10) Pub. No.: US 2008/0018863 A1
(43) Pub. Date: Jan. 24, 2008

(54) Projector with an equalizing temperature module

(75) Inventor: Chi-Hung Hsiao, Tapei County (TW)

Correspondence Address: BIRCH STEWART KOLASCH & BIRCH, PO BOX 747, FALLS CHURCH, VA, 22040-0747, US

(73) Assignee: BENQ Corporation

(21) Appl. No.: 11/822,508

(22) Filed: Jul. 6, 2007

(30) Foreign Application Priority Data
Jul. 18, 2006 (TW) 95126289

(51) Int. Cl. G03B 21/16

(52) U.S. Cl. 353/54; 353/57

(57) ABSTRACT

A projector comprises a case, an illuminant heat source, a thermal module, and an equalizing temperature module. The equalizing temperature module is disposed between the illuminant heat source and the thermal module. When the fluid flows from the illuminant heat source to the equalizing temperature module, the fluid flows through a relative high temperature region more than that of flowing through a relative low temperature region. The equalizing temperature module at least comprises a heat pipe and a plurality of heat sinks. The heat pipe has a first end located in the relative low temperature region and a second end located in the relative high temperature region. The heat pipe transfers heat from the relative high temperature region to the relative low temperature region by a cold fluid in the heat pipe. The plurality of heat sinks are disposed on the heat pipe to increase the area of heat conduction. The projector can uniform the fluid temperature by means of the equalizing temperature module so as to increase life time and reliability of the thermal module.

### BACKGROUND OF THE INVENTION

(1) Field of the Invention

The present invention relates to a projector, more particularly to a projector with an equalizing temperature module disposed therein.

(2) Description of the Prior Art

Following the vigorous advancement of the high technology industry, the dimensions of an electronic component tend to minimize, the density of the components per unit area is getting higher, and the efficiency is getting powerful. Because of the above factors, the heat produced from the electronic components is getting higher. If there is not any suitable heat dissipation method to eliminate the heat from the electronic components, the heat affects the stability of the whole device and reduces the life time of the electronic components. Therefore, how to exhaust the heat from the electronic device to avoid interior electronic components overheating is a significant issue. The requirement of the heat dissipation is very stern, especially to the electronic product, such as projector and notebook.

Please refer to FIG. 1, which is a schematic partial view of a conventional projector. The heat dissipation component of a conventional projector 100 is a fan 120. The fan 120 is to exhaust the heat produced from an illuminant heat source 104 out of the projector 100 via a wind outlet 102. However, the heat would be increased while the illuminant offered by the illuminant heat source 104 increases. Hence, it is a wide use of using several fans to dissipate heat. Moreover, the distances between the illuminant heat source 104 and the fans 120 are not equal each other in the fabricating process of the projector 100 because of the dimensional factor. As a result, the temperature of a fluid exhausted from the fan 120a near the illuminant heat source 104 is higher. In contrast, the temperature of a fluid exhausted from the fan 120b far from the illuminant heat source 104 is lower.

In the above situation, if the fan 120a exhausts the high temperature wind is closer to the wind outlet 102, the high temperature wind fluid exhausted out of the projector may possibly hurt users. Moreover, the fans are located at different environments with different temperatures in order to cause different lifetimes. It is then that the entire reliability may be affected.

### SUMMARY OF THE INVENTION

An objective of the present invention is to provide an equalizing temperature module for equalizing the fluid temperature of a fluid before the fluid is exhausted through a thermal module.

Another objective of the present invention is to provide a projector with the above equalizing temperature module disposed therein. Therefore the projector of the present invention is very reliable.

According to the above objectives or the other objectives, the present invention provides an equalizing temperature module disposed between a thermal module and an illuminant heat source. Wherein a space is existed between the illuminant heat source and the equalizing temperature module, and a fluid is guided from the illuminant heat source to the equalizing temperature module via the space. Moreover, the fluid flows through a relative high temperature region more than that of flowing through a relative low temperature region while the fluid flows to the equalizing temperature module.

The equalizing temperature module mainly comprises at least a heat pipe and a plurality of heat sinks, wherein the heat pipe with a cold fluid therein has a first end and a second end. The first end is located in the relative low temperature region, and the second end is located in the relative high temperature region. The heat pipe is used to transfer heat from the relative high temperature region to the relative low temperature region via a cold fluid inside the heat pipe. Besides, the plurality of heat sinks are disposed on the heat pipe for increasing the area of heat conduction of the heat pipe.

The present invention also provides a projector mainly comprising a case, an illuminant heat source, a thermal module, and the above equalizing temperature module. Wherein, the case has a wind outlet. The illuminant heat source, the thermal module, and the equalizing temperature module are disposed inside the case. The thermal module is located beside the wind outlet, and the equalizing temperature module is disposed between the illuminant heat source and the thermal module.

In one embodiment of the present invention, the first end of the heat pipe is located in the relative low temperature region, and the second end is located in the relative high temperature region. Wherein, the position of the first end is higher than the position of the second end.

In one embodiment of the present invention, an angle formed by the heat sinks and the major axis of the heat pipe is a designated angle, which is not a 90-degree, for preventing the light of the illuminant heat source passing through from the equalizing temperature module to the thermal module.

In one embodiment of the present invention, the above cold fluid is selected from one of the group of water, refrigerant, and acetone.

In one embodiment of the present invention, the above equalizing temperature module is adjacent to the thermal module, and the heat sinks are uniformly distributed over the heat pipe.

In one embodiment of the present invention, the above thermal module comprises at least a fan, and the distance between the equalizing temperature module and the thermal module is substantially equal.

In one embodiment of the present invention, the above thermal module can be a matrix-array fan set or a parallel fan set.

In one embodiment of the present invention, the above relative low temperature region represents a longer path that the fluid flows from the illuminant heat source to the equalizing temperature module in the space. And the relative high temperature region represents a shorter path that the fluid flows from the illuminant heat source to the equalizing temperature module in the space.

In one embodiment of the present invention, the internal part of the heat pipe is an enclosed piping, and the cold fluid is in the enclosed piping.

The equalizing temperature module of the present invention can equalize the temperature of the fluid so as to let the components therein use the same value of power to achieve the same cooling effect. Further that, the components are more reliable.

These and the other objectives of the present invention will no doubt become obvious to those of ordinary skill in the art after reading the following detailed description of the preferred embodiment which is illustrated in the various figures and drawings.

### BRIEF DESCRIPTION OF THE DRAWINGS

The present invention will now be specified with reference to its preferred embodiment illustrated in the drawings, in which:

FIG. 1 illustrating a part view of a conventional projector;

FIG. 2 illustrating a part view of a projector according to one embodiment of the present invention;

FIG. 3 illustrating a top view of the projector according to another embodiment of the present invention; and

FIG. 4 illustrating a schematic diagram of an equalizing temperature module according to another embodiment of the present invention.

### DESCRIPTION OF THE PREFERRED EMBODIMENT

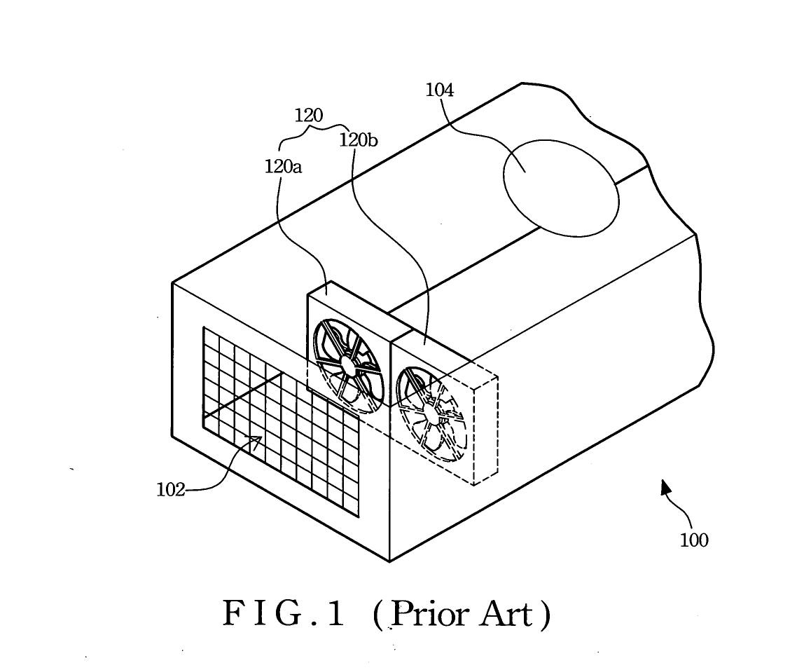

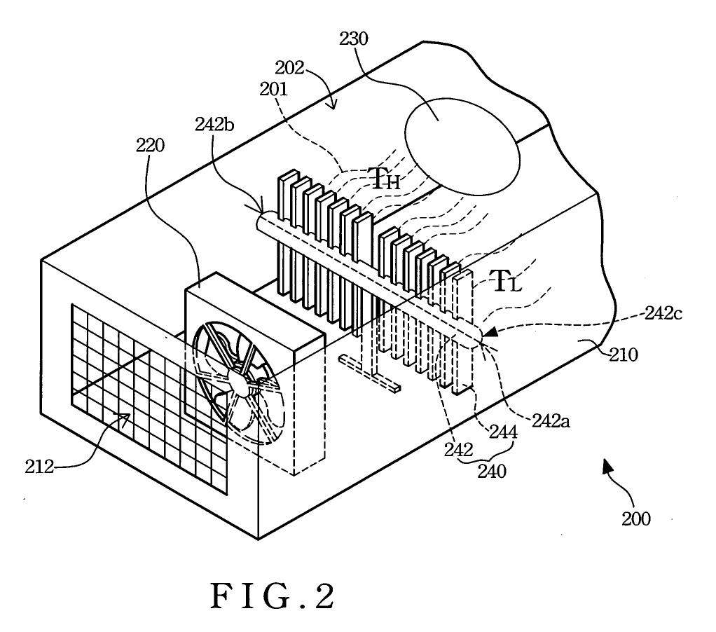

Please refer to FIG. 2, which illustrates a schematic sectional view of a projector according to one embodiment of the present invention. The projector 200 comprises a case 210, a thermal module 220, an illuminant heat source 230, and an equalizing temperature module 240. Wherein, the thermal module 220, the illuminant heat source 230, and the equalizing temperature module 240 are all disposed inside the case 210. The case 210 has a wind outlet 212, and the thermal module 220 is located beside the wind outlet 212 for exhausting the high temperature gas produced from the illuminant heat source 230 or other electronic components (not shown in FIG. 1).

Generally speaking, the illuminant heat source 230 can be a metal halide lamp. The thermal module 220 can be a fan, of course, or can be constructed by a matrix-array fan set or a parallel fan set.

The equalizing temperature module 240 is disposed between the illuminant heat source 230 and the thermal module 220. In this embodiment, the equalizing temperature module 240 is adjacent to the thermal module 220, and the distance between the equalizing temperature module 240 and the thermal module 220 is substantially equal.

Besides, a space 202 is existed between the illuminant heat source 230 and the equalizing temperature module 240, and a fluid 201 is in the space 202. In this embodiment, the fluid 201 is gas. The heat produced from the illuminant heat source 230 makes the temperature of the fluid inside the space 202 be non-uniform because of the thermal module 220. Detailed description as following, the work of the thermal module 220 makes the space 202 guide the fluid 201 to flow from the illuminant heat source 230 to the equalizing temperature module 240.

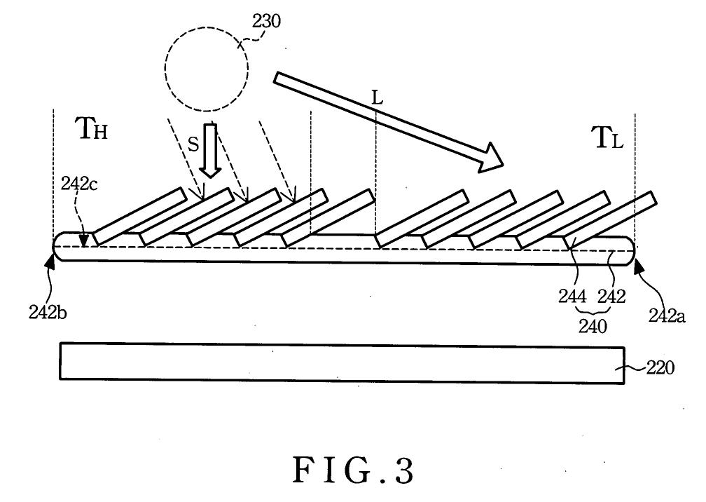

Please refer to FIG. 3, which illustrates a schematic top view of the projector according to another embodiment of the present invention. The related positions of the illuminant heat source 230, the equalizing temperature module 240, and the thermal module 220 are shown in FIG. 3. People who are skilled in the art should know that the fluid 201 moves to the region of low flow resistance and passes through the equalizing temperature module 240 in high-speed because of the rotation of the fan of the thermal module 220 while the fluid 201 flows from the illuminant heat source 230 to the equalizing temperature module 240.

In other words, when the fan rotates, the region of low flow resistance is a shorter path S that the fluid 201 flows from the illuminant heat source 230 to the equalizing temperature module 240, and the fluid 201 passes through the equalizing temperature module 240 along the path S in high-speed. The region of high flow resistance is a longer path L that the fluid 201 flows from the illuminant heat source 230 to the equalizing temperature module 240, and the fluid 201 passes through the equalizing temperature module 240 along the path L in low-speed.

Therefore, the more the fluid 201 passes through the equalizing temperature module 240 along the path S with low flow resistance so as to result in a relative high temperature region TH. The less the fluid 201 passes through the equalizing temperature module 240 along the path L with high flow resistance in order to result in a relative low temperature region TL. As a result, the fluid 201 flows through the relative high temperature region TH mostly and flows through a relative low temperature region TL rarely while the fluid 201 flows to the equalizing temperature module 240.

With above description, the relative low temperature region TL corresponds to the longer path L that the fluid 201 flows from the illuminant heat source 230 to the equalizing temperature module 240 in the space 202. And the relative high temperature region TH corresponds to the shorter path S that the fluid 201 flows from the illuminant heat source 230 to the equalizing temperature module 240 in the space 202.

The equalizing temperature module 240 mainly comprises at least a heat pipe 242 and a plurality of heat sinks 244. Wherein the heat pipe 242 has a first end located in the relative low temperature region TL, and a second end located in the relative high temperature region TH. The internal part of the heat pipe 242 is an enclosed piping, which is to transfer heat by way of the latent heat of phase change between liquid and vapor of a cold fluid inside the enclosed piping.

Detailed description as following, in a vaporization section, such as the second end 242b of the heat pipe 242, the cold fluid brings heat away from the relative high temperature region TH by way of the latent heat of evaporation, and then a vacuum space inside the heat pipe 242 is filled the vapor up. Finally, in a condensation section, such as the first end 242a of the heat pipe 242, the above vapor is condensed into liquid phase to release heat. The cold fluid flows back to the vaporization section to proceed the cycle of the phase change by way of the capillary force offered by a capillary structure (not shown in figure) inside the pipe, thereby to transfer the heat from the vaporization section to the condensation section effectively and continuously, and make the temperature of the fluid that flows through the outside of the heat pipe 242 be equalized. In the embodiment, the cold fluid can be water, refrigerant, acetone, etc.

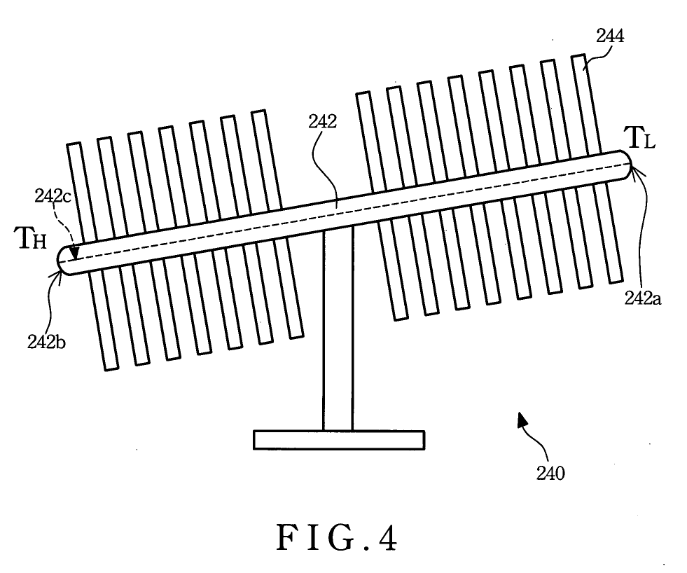

Please refer to FIG. 4, which illustrates a schematic diagram of the equalizing temperature module according to another embodiment of the present invention. Moreover, if the relative high temperature region TH is known during the projector 200 in operation, the position of the second end 242b of the heat pipe 242, such as the above vaporization section, can be lower than the position of the first end 242a of the heat pipe 242, such as the above condensation section, so as to speed up the rate that the cold liquid inside the heat pipe 242 moves to the condensation section after absorbing the heat in the vaporization section and speed up the rate that the cold liquid inside the heat pipe 242 moves to the vaporization section after condensing in the condensation section, and improve the efficiency of the equalizing temperature module 240. Besides, the equalizing temperature module 240 also can utilize several heat pipes simultaneously to improve the efficiency.

Please refer to FIG. 2 again, the heat sinks 244 are uniformly distributed over the heat pipe 242 for increasing the area of heat conduction of the heat pipe 242. Moreover, people skilled in the art can adjust the angle formed by the heat sinks 244 and the major axis of the heat pipe 242c to be a designated angle, which is not a 90-degree, for preventing the light of the illuminant heat source 230 passing through from the equalizing temperature module 240 to the thermal module 220 according to the demand.

In other words, the heat sinks 244 not only increase the area of the heat conduction, but also prevent the light of the illuminant heat source 230 passing through from the wind outlet 212. Therefore, the equalizing temperature module 240 also has a function of preventing light leak, thus the projector 200 dose not need to add any component of preventing light leak.

It is noted that, the application of the equalizing temperature module 240 of the present invention is not limited by the above embodiments. That is, the equalizing temperature module 240 of the present invention not only can be applied to the projector 200, but also can be applied to other electric devices which have heat sources and are easily to produce the non-uniform distribution of the heat.

As aforesaid, after the fluid with non-uniform temperatures between the equalizing temperature module 240 and the illuminant heat source 230 flows through the equalizing temperature module 240, the above fluid temperature will approach a uniform state. As a result, using the same components of thermal module 220 can achieve the same cooling effect according to the same power, thereby to have reliable components. Besides, the temperature of the fluid exhausted from the thermal module 220 is uniform, hence it is not easily to hurt users.

With the example and explanations above, the features and spirits of the invention are hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. An equalizing temperature module disposed between a thermal module and an illuminant heat source, and a space being existed between the illuminant heat source and the equalizing temperature module, wherein a fluid is guided from the illuminant heat source to the equalizing temperature module via the space, the fluid flows through a relative high temperature region more than that of flowing through a relative low temperature region while the fluid flows to the equalizing temperature module, and the equalizing temperature module comprising:
at least a heat pipe having a first end and a second end, the first end being located in the relative low temperature region, and the second end being located in the relative high temperature region; and
a plurality of heat sinks being disposed on the heat pipe for increasing the area of heat conduction of the heat pipe.

2. The equalizing temperature module of claim 1, wherein the position of the first end is higher than the position of the second end.

3. The equalizing temperature module of claim 1, wherein an angle formed by the heat sinks and the major axis of the heat pipe is a designated angle, which is not a 90-degree, for preventing the light of the illuminant heat source passing through from the equalizing temperature module to the thermal module.

4. The equalizing temperature module of claim 1, wherein the heat pipe comprises a cold fluid inside the heat pipe, and the heat pipe is to transfer heat from the relative high temperature region to the relative low temperature region by the cold fluid.

5. The equalizing temperature module of claim 4, wherein the internal part of the heat pipe is an enclosed piping, and the cold fluid is in the enclosed piping.

6. The equalizing temperature module of claim 4, wherein the cold fluid is selected from one of the group of water, refrigerant, and acetone.

7. The equalizing temperature module of claim 1, wherein the equalizing temperature module is adjacent to the thermal module, and the heat sinks are uniformly distributed over the heat pipe.

8. The equalizing temperature module of claim 1, wherein the distance between the equalizing temperature module and the thermal module is substantially equal.

9. The equalizing temperature module of claim 1, wherein the thermal module comprises a matrix-array fan set.

10. The equalizing temperature module of claim 1, wherein the thermal module comprises a parallel fan set.

11. The equalizing temperature module of claim 1, wherein the relative low temperature region represents a longer path that the fluid flows from the illuminant heat source to the equalizing temperature module in the space, and the relative high temperature region represents a shorter path that the fluid flows from the illuminant heat source to the equalizing temperature module in the space.

12. A projector comprising:
a case having a wind outlet;
an illuminant heat source disposed inside the case;
a thermal module being disposed inside the case and located beside the wind outlet;
an equalizing temperature module being disposed inside the case and between the illuminant heat source and the thermal module, and a space being existed between the illuminant heat source and the equalizing temperature module, wherein a fluid is guided from the illuminant heat source to the equalizing temperature module via the space, the fluid flows through a relative high temperature region more than that of flowing through a relative low temperature region while the fluid flows to the equalizing temperature module, and the equalizing temperature module comprising:
at least a heat pipe having a first end and a second end, the first end being located in the relative low temperature region, and the second end being located in the relative high temperature region; and
a plurality of heat sinks being disposed on the heat pipe for increasing the area of heat conduction of the heat pipe.

13. The projector of claim 12, wherein the position of the first end is higher than the position of the second end.

14. The projector of claim 12, wherein an angle formed by the heat sinks and the major axis of the heat pipe is a designated angle, which is not a 90-degree, for preventing the light of the illuminant heat source passing through from the equalizing temperature module to the thermal module.

15. The projector of claim 12, wherein the heat pipe comprises a cold fluid inside the heat pipe, and the heat pipe is to transfer heat from the relative high temperature region to the relative low temperature region by the cold fluid.

16. The projector of claim 15, wherein the internal part of the heat pipe is a enclosed piping, and the cold fluid is in the enclosed piping.

17. The projector of claim 15, wherein the cold fluid is selected from one of the group of water, refrigerant, and acetone.

18. The projector of claim 12, wherein the equalizing temperature module is adjacent to the thermal module, and the heat sinks are uniformly distributed over the heat pipe.

19. The projector of claim 12, wherein the distance between the equalizing temperature module and the thermal module is substantially equal.

20. The projector of claim 12, wherein the thermal module comprises a matrix-array fan set.

21. The projector of claim 12, wherein the thermal module comprises a parallel fan set.

22. The projector of claim 12, wherein the relative low temperature region represents a longer path that the fluid flows from the illuminant heat source to the equalizing temperature module in the space, and the relative high temperature region represents a shorter path that the fluid flows from the illuminant heat source to the equalizing temperature module in the space.
